(19) United States
(12) Patent Application Publication
(10) Pub. No.: US 2009/0173730 A1
(43) Pub. Date: Jul. 9, 2009

(54) HOB AND METHOD FOR OPERATING A HOB

(75) Inventors: Martin Baier, Ettlingen (DE); Mathias Bellm, Bretten (DE); Markus Jungbauer, Bruchsal-Obergrombach (DE); Gerd Knappe, Bretten (DE); Wolfgang Metzger, Gondelsheim (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/274,672

(22) Filed: Nov. 20, 2008

(30) Foreign Application Priority Data
Nov. 21, 2007 (DE) 102007057076.9

(51) Int. Cl. H05B 3/68

(52) U.S. Cl. 219/446.1

(57) ABSTRACT

In order in the case of a hob (11) with operating toggles (19a-19d) placed on a front panel (17) to render visible the association between a contacted operating toggle and the hotplate (15a-15d) adjustable with said operating toggle, on the latter is provided a proximity or contact sensor. If the operating toggle (19a-19d) together with contact sensor is contacted by a hand (29), the LED (33) or other display associated with the hotplate (15) associated with said operating toggle is illuminated, which can be placed directly alongside hotplate (15).

### CROSS REFERENCE TO RELATED APPLICATIONS

This application claims priority to German Application Number 102007057076.9 filed on Nov. 21, 2007, the contents of which are incorporated by reference.

### FIELD OF THE INVENTION

The invention relates to a hob with several distributed hotplates having a heating device, which in turn has an electromechanical operating element, as well as to a method for operating such a hob.

### BACKGROUND OF THE INVENTION

On the top of hobs having several hotplates, it is known to provide in the vicinity of the hob plate so-called touch switches as operating elements or alternatively, electromechanical operating elements such as rotary toggles. Through corresponding markings or characters and symbols printed in fixed manner on the hob plate alongside the operating elements, it is possible at a glance to determine which of the many hotplates is associated an with an operating element or is provided for the operation thereof. In the case of hobs, which are more particularly constructed together with an oven, where the operating elements are not located at the top on the hob, but instead on a front or panel in front of and below the hob, such markings alongside the operating elements cannot be detected in normal operation, i.e., when an operator is close to the hob. For this purpose, an operator must either bend down or step back two steps and even then, due to poor lighting conditions or other reasons, it is usually not very easy to detect such markings. Thus, it is possible for a user to inadvertently activate an incorrect hotplate. The operation of an incorrect hotplate is not only annoying, but in certain circumstances can even be dangerous and give rise to injury or damage.

### BRIEF DESCRIPTION OF THE DRAWINGS

Embodiments of the invention are described hereinafter relative to the attached diagrammatic drawings, wherein show:

FIG. 1 illustrates an oblique view of an inventive hob on a cooker with several operating toggles on a front panel in front of the hob plate.

FIG. 2 illustrates a section through the front panel of the hob of FIG. 1 with a proximity sensor system over the operating toggle.

FIG. 3 illustrates a variant of FIG. 2 with a contact sensor system on the operating toggle.

FIG. 4 illustrates a plan view of the hob of FIG. 1 with four hotplates and different possibilities for displaying an approach of the hand to an operating toggle associated with a particular hotplate.

### DETAILED DESCRIPTION OF THE EMBODIMENTS

One embodiment of the invention is to provide an aforementioned hob and an aforementioned operating method for the same making it possible to obviate the problems of the prior art and in particular allow a safe and instinctive operation of a hob.

This problem is solved by a hob having the features and methods claimed herein. Advantageous and preferred developments of the invention form the object of the further claims and are explained in greater detail hereinafter. By express reference, the wording of the claims is made into part of the content of the description.

In each case, one hotplate has an electromechanical operating element for the operation thereof, the operating elements being constructed in such a way that a power setting or adjustment can take place by turning or sliding of the operating element, preference being given to turning. According to one embodiment of the invention, a proximity and/or contact sensor system is provided and is referred to hereinafter solely as the proximity sensor system, but can have both functions. It is constructed for the detection of an approach, or contact of, an operator in the case of a specific operating element. Thus, the hob can detect if an operator moves a hand very close to or even contacts an operating element. The hob also has a display device with several display means, an individual display means being provided for each hotplate with a clear association of said display means with said hotplate. This is explained in greater detail hereinafter. The hob has a control unit with which it is possible to control a display means or the display device with the display means in such a way that on detecting an approach or contact by means of the proximity sensor system to an operating element, the display means of the hotplate associated with said operating element is activated in such a way that as a result of the display means an operator can detect which particular operating element he or she is approaching or contacting and therefore which hotplate can be operated therewith.

An optical association between operating element and hotplate can be very rapidly and instinctively detected if a correspondingly favourable construction is adopted, which is possible through illuminated displays and further reference will be made thereto hereinafter. Admittedly, it is not possible in each case when a specific hotplate is to be operated to initially prevent the contacting of the inappropriate or associated operating element. However, if the operator then detects by means of the corresponding activated display means that a contacted operating element belongs to an undesired hotplate, said operator can contact another, preferably an adjacent operating element and then check by means of the activated display means whether it now matches the desired hotplate.

According to another embodiment of the invention, the proximity sensor system is located on the front or panel of the hob, i.e., in front of the same and at a lower level. In a preferred embodiment of the invention, on such a front or panel are provided all the operating elements of the same type and consequently also the proximity sensor system. With such a combination of hob and oven, it is typical to have such an arrangement at the front of a panel.

In an alternative embodiment of the invention, there is not only a single proximity sensor system for several or all the operating elements, but instead on or for each operating element there is a separate proximity sensor system. It can be advantageous if such a proximity sensor system is integrated into the operating element, both functionally and at least partly physically or from the technical design standpoint.

Fundamentally, such a proximity sensor system can be constructed in several ways, but preference is given a capacitive construction or a proximity sensor system operating according to a capacitive principle. Such proximity or contact sensors are for example known from U.S. Pat. No. 5,917,165. With particular advantage after contacting the operating element or specific electrically conductive surface areas thereof by the hand of an operator, a capacitive leakage or discharge current can be measured via said hand and from the same a contact can be detected. Alternatively by means of a coupling capacitance of a contacting hand a resonant circuit detuning can be detected.

Another practicable alternative is an optical principle for the proximity sensor system, particularly if the latter is intended to detect an approach as opposed to a contact. Optical sensors, particularly reflection light barriers or the like are suitable for detecting an approach or contact. If, for example, a hand is close enough to the sensor system, an emitted light beam can be correspondingly reflected back and this is detected as an orderly approach. This principle is generally known and is for example described in DE 197 00 836 C1.

There are numerous possibilities for the arrangement of the display means. According to a first basic embodiment of the invention, it is possible to provide the same directly and close to the hotplate, for example on the hotplate outer edge or somewhat beyond the same, so that detection is also possible when a saucepan is correctly placed on the hotplate. Advantageously, the display means are located beneath a hob plate, particularly if they have a luminous construction this enables the protection thereof against damage. Display means can generally be constructed as illuminants, particularly when at least one such illuminant is provided as the display means for each hotplate. If the display means are provided close to the hotplate, they are advantageously distributed around the same as dot or line-like phenomena. When placed beneath the hob plate it is also advantageous to construct the display means or illuminants in a heat-resistant manner, particularly for temperatures of a few 100° C. One illuminant possibility is constituted by LEDs, particularly heat-resistant LEDs.

According to a second basic embodiment of the invention, the display means are not located close to the given hotplate, but are instead combined in a display area and are spatially juxtaposed. This is less costly from the constructional standpoint and can be better integrated into the hob. The display means can be positioned relative to one another in the same way as the hotplates which said display means represent. If, for example, as is conventionally the case, the hotplates are distributed in quadrangular manner on the hob with two rear and two front hotplates, the display means provided for said hotplates can have this arrangement. In this second embodiment of the invention with a common display area, it is considered adequate to represent each hotplate by a single illuminant as the display means. Then said display means represents a hotplate at this point and does not directly characterize it as in the first basic development.

Advantageously, the operating elements are electromechanical controlling elements with a rotary function or for power setting by rotation. They have a rotary toggle as a handle, as is known per se. The proximity sensor system for example has sensor elements on the outer circumference of the rotary toggle, i.e., where such a toggle is contacted in the case of instinctive grasping. Such sensors arranged on the outer circumference are advantageously constructed as aforementioned capacitive contact sensors. Admittedly such contact sensors can fulfil further functions, but within the scope of the invention they are provided for detecting a contact or gripping and are correspondingly constructed and activated.

The display means by means of which an operator can detect which operating element is being approached or contacted can also have further functions, for example, as a saucepan detection display, temperature or residual heat display or as the set power stage display. The function of operating element approach or contact can then for example be displayed in the case of an already illuminated display means by varyingly strong lighting, flashing, etc.

Whereas in the case of providing pure contact sensor system with sensors to be contacted said contact is necessary, in the case of a proximity sensor system, the range for detecting a hand can be up to 20 cm, but advantageously less. With particular advantage such a range is selected as a few centimetres, for example 5 cm to 10 cm. Moreover the range must be smaller than the distance from an adjacent operating element, so that the approach to an operating element is accurately detected and can then also be displayed.

In an operating method according to one embodiment of the invention, after an operator has approached or grasped an operating element he or she can activate the display means belonging to the hotplate and to which the operating element belongs or for whose power setting the operating element is responsible. If by means of the activated or lit up display means, the operator sees that it is not the operating element of the desired hotplate, the operator will generally select and try out an operating element alongside it. It can be provided that the display means of the first contacted operating element is immediately deactivated or erased or can still afterglow for some time. This makes it possible either to accentuate the display of the next contacted operating element, namely when only it is illuminated, or through an afterglow of a few seconds there can be a better orientation for the hob. Through the afterglow the entire illumination period and therefore the impression time is extended.

These and further features can be gathered from the claims, description and drawings and the individual features, both singly or in the form of subcombinations, can be implemented in an embodiment of the invention and in other fields and can represent advantageous, independently protectable constructions for which protection is claimed here. The subdivision of the application into individual sections by means of subheadings in no way restricts the general validity of the statements made thereunder.

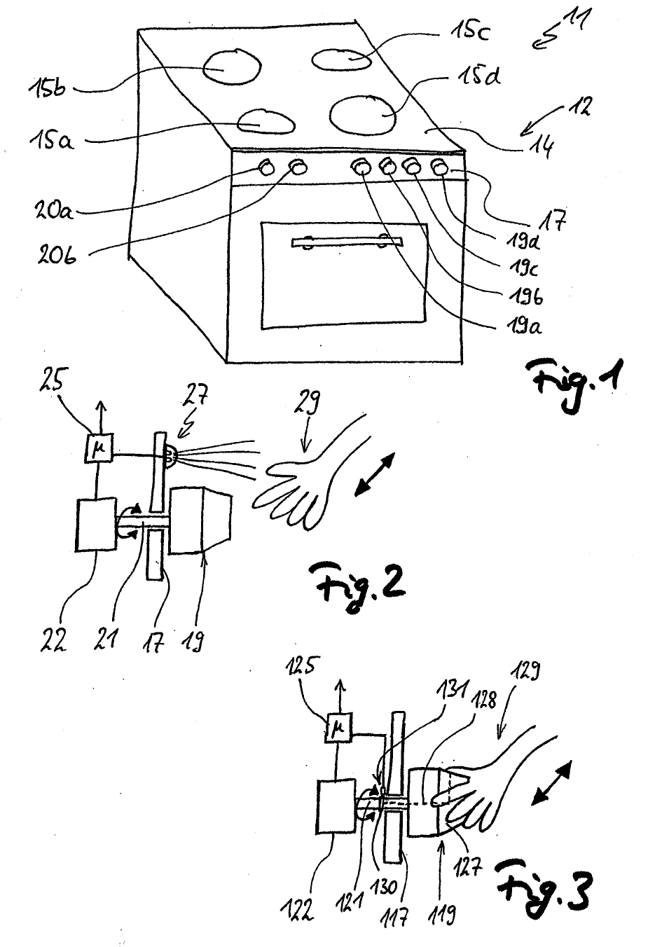

Turning now to the Figures, FIG. 1 is an oblique view of a hob 11 on a cooker 12. The hob 11 has a hob plate 14, for example of transparent glass ceramic, with four distributed hotplates 15a-d, as is known from the prior art. At the front on the cooker 12 and below the hob 11 is provided a front panel 17, beneath which is located an oven, to which no further reference will be made. There are four operating toggles 19a-d to the right on the front panel 17. To the left on the front panel 17 there are two operating toggles 20a and 20b for oven functions. Operating toggle 19a is associated with hotplate 15a for its operation or power setting. This applies correspondingly for the remaining hotplates and the remaining operating toggles.

As is known from the prior art, operating toggle 19a makes it possible to operate, i.e., switch on and adjust the power level of hotplate 15a. The arrangement shown in FIG. 1 corresponds to a conventional arrangement, so that from left to right the operating toggles are associated with the hotplates starting from the left and following in clockwise direction. If an operator now stands in front of the cooker 12 or hob 11, it is only possible with the above-described effort to detect which operating toggle 19a-d must be contacted for switching on or modify the power level of a specific hotplate 15.

According to a first aspect of the invention, FIG. 2 is a diagrammatic section through a front panel 17 according to FIG. 1. The operating toggle 19 is located on a rotary spindle 21, which extends through the otherwise closed front panel 17 to a standard power control device 22. By turning the operating toggle 19 by means of the power control device 22 it is possible to carry out a power setting on the associated hotplate or its heating device.

On the front panel 17, above operating toggle 19, is provided a proximity sensor system 27 with an action direction in an area in front of the panel 17. Said proximity sensor system 27 is connected to a control unit 25 which, as shown here, is also connected to the power control device 22. In a manner that is not shown in the figure, control unit 25 is connected to display means, to which further reference will be made hereinafter.

The proximity sensor system 27 is known per se from the prior art and can for example be constructed as a so-called reflection light barrier. To this extent and as indicated it can emit light, advantageously with a transmitter in the IR-range. If a hand 29 is now brought close to the operating toggle 19, for example in a predefined distance therefrom of for example 5 cm to 10 cm, light is reflected by it. This can be detected by the proximity sensor system 27 together with the control unit 25. This is evaluated by the control unit as an approach and an intentional operation and activation takes place of a display means which is associated with the hotplate associated with said operating toggle 19.

In this embodiment of the invention, importance is attached to the distance from the operating toggle 19 or front panel 17 at which the proximity sensor system 27 detects the hand 29. It is important to detect precisely which operating toggle the hand 29 is approaching. Generally there is one such proximity sensor system 27 per operating toggle 19. It can naturally also be located or embedded the front panel 17 or behind the same with a transparent window or the like. Alternatively, there can be two similar proximity sensor systems, for example over the far left operating toggle 19a and the far right operating toggle 19d. It is possible by means of a type of cross bearing to detect which operating toggle 19 is being approached by the hand 29.

A distance of well over 10 cm does not make sense for the detection of a planned approach to an operating toggle 19, because the approach direction can also be inclined to the front panel 17. An activation of a display means should only take place when it can be reliably detected which operating toggle 19 is in fact being approached by a hand 29.

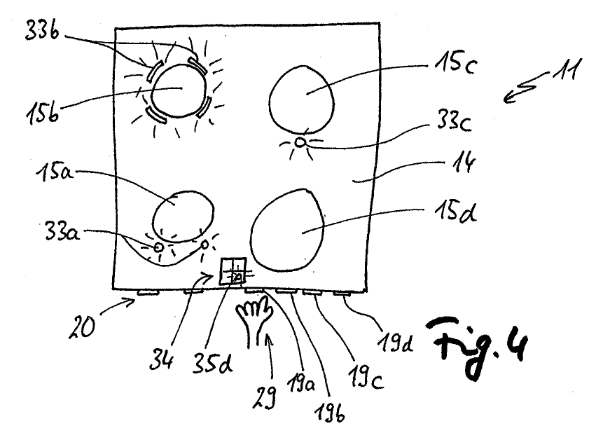

The problem of some uncertainty when a hand is approaching the operating toggle can be avoided with the arrangement of an alternative development of the invention according to FIG. 3. Here, in the case of a substantially similar construction of an operating toggle 119 on a front panel 117, a contact sensor 127 can be directly provided on the operating toggle 119. Said contact sensor 127 is advantageously made from metal, for example stainless steel, or is electrically conductive and at least forms the front part of the toggle 119, which is normally contacted, or even the entire top side. Such an operating toggle is known for example in similar form from US 2007/181410 A1. An electrical connection 128, shown in broken line form and running on the operating toggle, provides the contact with a contact ring 139 placed on the rotary spindle 121. Engagement takes place here of a slider 131 together with the electrical connection to control unit 125, so that the latter can detect when a hand 129 has contacted the operating toggle 119 or contact sensor 127. The operating principle of contact sensor 127 and control unit 125 can be that of a capacitive sensor described in US 2007/181410 A1. The contact sensor can also be covered with an insulating coating or can be positioned beneath a cover on the operating toggle. What is important in this construction as a capacitive sensor is that it can detect a contact with the hand by a change in capacitance and retransmits this information to the control unit. In the case of an adequately high sensitivity, such a capacitive sensor that can also be used for the construction of a proximity sensor, the capacitive coupling between sensor and hand also bridges a path of a few centimeters through the air.

An advantage of the arrangement according to FIG. 3 with a contact sensor is that this detects the contacting of an operating toggle 119 with a hand 129 or the activation of the display means triggered by means of the control unit 125. An operator must admittedly briefly contact each operating toggle in seeing the desired hotplate. However, there are no difficulties in detecting the particular operating toggle being approached by the hand.

Detached from the nature of the detection of the approach to an operating toggle or the contact therewith, FIG. 4 illustrates different possibilities for the display or display means. In the case of the hotplate 15a front left on hob 11, there are two LEDs 33a beneath the hob plate 14. They light up through the hob plate 14 when correspondingly activated, for example when the hand 29 approaches to within an adequately short distance with respect to the far left operating toggle 19a. The arrangement of two such LEDs 33 in front of the hotplate 15a is considered adequate, because an operator is normally looking from this direction.

In the case of the rear left hotplate 15b, there are four strip-like LEDs 33b roughly uniformly distributed around the hotplate. They represent an activation or power setting of the hotplate 15b or that the associated operating toggle 19b has been contacted or approached and this can be detected from all sides.

In the case of the bottom right hotplate 15c, there is only one LED 33c, once again in front of hotplate 15c. This represents a construction with the minimum constructional expenditure when only one LED is required and activated.

The front right hotplate 15d has no LED directly associated therewith, unlike in the case of the remaining hotplates. In this case, remote therefrom and in the front centre on hob 11 or hob plate 14 there is a separate display 34 with subdivisions, which by means of four areas symbolically represents the four hotplates 15a-d. In order to display the contact or approach to the operating toggle 19d belonging to hotplate 15d, a LED 35d is activated or illuminated front right on display 34. Thus, an operator does not look directly onto the desired hotplate 15, but instead looks at the display 34 and by means of the display means or luminous LED 35d lighting up in one of the fields detects whether the just contacted or approached operating toggle belongs to the desired hotplate. This type of display or this provision of display means on a single central, separate display 34 has the advantage that such a separate display can be installed and electrically connected as an independent, small module beneath the hob plate 14. The other solutions with the LED 33 directly on the hotplates 15a-c admittedly permit an even faster and more instinctive detection, but involve much higher installation and component costs.

1. A hob comprising a plurality of distributed hotplates wherein each hotplate comprises a heating device and is associated with an electromechanical operating element to set a power level by turning or sliding said electromechanical operating element, said hob comprising:
a proximity or contact sensor system configured to detect approach or contact of one of said electromechanical operating elements by a hand of an operator;
a display device with a plurality of display elements wherein each one of the plurality of hotplates is associated with one of the plurality of display elements, wherein said display device indicates which one of the plurality of hotplates is approached or contacted by said hand of said operator; and
a control unit configured to control the display device to indicate when said one of said electromechanical operating elements is approached or contacted by said hand of said operator by activating the corresponding one of the plurality of display elements associated with said one of the plurality of hotplates.

2. The hob according to claim 1, wherein the proximity or contact sensor system is located on a front panel of the hob and all the electromechanical operating elements of the same nature are provided on said front panel.

3. The hob according to claim 1, wherein the proximity or contact sensor system is separately provided for each electromechanical operating element and is integrated into said electromechanical operating element.

4. The hob according to claim 1, wherein the proximity or contact sensor system is constructed as capacitance sensor thereby measuring a capacitive discharge when contacted by the hand of the operator.

5. The hob according to claim 1, wherein the proximity or contact sensor system is constructed using optical sensors, thereby detecting reflection of light when the electromechanical operating element is approached or contacted by the hand of the operator.

6. The hob according to claim 1, wherein the display device are in each case provided directly close to an outer edge of the hotplate and below a hob plate.

7. The hob according to claim 6, wherein at least one single illuminant is provided as the display device is resistant to temperatures up to several 100° C.

8. The hob according to claim 6, wherein the display device comprises LEDs as illuminants.

9. The hob according to claim 1, wherein the display device is provided below a hob plate of the hob in a common display area and closely spatially juxtaposed.

10. The hob according to claim 9, wherein a mutual arrangement of the display device corresponds to the mutual arrangement of the hotplates on the hob.

11. The hob according to claim 1, wherein the operating elements comprises electromechanical power controlling elements with a rotary function as well as a rotary toggle as a handle, wherein the proximity or contact sensor system has one or more sensors on the outer circumference of the rotary toggle.

12. The hob according to claim 1, wherein a range of the proximity or contact sensor system for detecting the approach of an operator's hand with respect to the operating element is less than 20 cm.

13. The hob according to claim 1, wherein a range of the proximity or contact sensor system for detecting the approach of an operator's hand with respect to the operating element is less than 5 cm.

14. A method for operating a hob comprising a plurality of distributed hotplates wherein each hotplate comprises a heating device and is associated with an electromechanical operating element to set a power level by turning or sliding said electromechanical operating element, said hob further comprising a
a proximity or contact sensor system configured to detect approach or contact of one of said operating elements by an operator,
a display device with a plurality of display elements wherein each one of the plurality of hotplates is associated with one of the plurality of display elements wherein said display device indicates which one of the plurality of hotplates is approached or contacted by said operator, and
a control unit controlling the display device and indicating when said one of operating elements is approached or contacted by said operator by activating the corresponding one of the plurality of display elements associated with said one of the plurality of hotplates,
said method comprising the steps of:
detecting by said control unit of the hob an approach or contact of an operator with respect to the electromechanical operating element; and
displaying on the display device a visual activation or illumination an indication as to which hotplate is associated with the operating element approached or contacted by the operator.

15. The method according to claim 14, wherein the display device is activated or illuminated at least for the time period during which an operator's hand is close to or contacting the associated operating element.

16. The method according to claim 14, wherein the display device is activated or illuminated at least for the time during which an operator's hand is close to or contacting the associated operating element plus at least two seconds after said operator's hand is withdrawn or no longer contacting the associated operating element.

17. The method according to claim 14, wherein in the case that the operating element is not operated following approach or contact of the operator's hand, the display device of said operating element is immediately switched off.

18. A system for controlling a hob, comprising:
a plurality of hotplates, each hotplate comprising a heating element;
a plurality of rotary knobs, each rotary knob associated with and controlling operating of a respective one of the plurality of hotplates;
a plurality of proximity sensors, configured to detect either proximity of or contact by a hand of an operator to one of the plurality of rotary knobs;
a plurality of shafts, each shaft connected to a respective one of the plurality of rotary knobs;
a plurality of power control devices, each power control device connected to a respective one of the plurality of shafts, each power control device controlling a respective hotplate;
a plurality of illumination sources, wherein each hotplate is associated with at least one or more of a subset of the plurality of illumination sources; and
a controller receiving signals from at least one of the plurality of proximity sensors, wherein said controller is configured to activate said subset of the plurality of illumination sources associated with a particular hotplate associated with a particular rotary knob wherein the at least one of the plurality of proximity sensors detects the proximity of or contact by said hand of said operator.
